(19) United States
(12) Patent Application Publication
(10) Pub. No.: US 2024/0114499 A1
(43) Pub. Date: Apr. 4, 2024

(54) DETERMINATION OF A UE BEAM FOR MSG3 TRANSMISSION

(71) Applicant: QUALCOMM Incorporated, San Diego, CA (US)

(72) Inventors: Mahmoud Taherzadeh Boroujeni, San Diego, CA (US); Tao Luo, San Diego, CA (US); Iyab Issam Sakhnini, San Diego, CA (US); Wooseok Nam, San Diego, CA (US); Xiaoxia Zhang, San Diego, CA (US); Peter Gaal, San Diego, CA (US); Yan Zhou, San Diego, CA (US)

(21) Appl. No.: 18/465,474

(22) Filed: Sep. 12, 2023

Related U.S. Application Data
(60) Provisional application No. 63/377,596, filed on Sep. 29, 2022.

(51) Int. Cl. H04W 72/044; H04L 1/08; H04W 74/08

(52) U.S. Cl. CPC H04W 72/046; H04L 1/08; H04W 74/0833

(57) ABSTRACT

This disclosure provides systems, methods, and devices for wireless communication that support determination of a UE beam for Msg3 transmission. In a first aspect, a method of wireless communication includes transmitting, to a network node, a first physical random access channel (PRACH) transmission and one or more repetitions of the first PRACH transmission using a plurality of beams, receiving, from the network node, a response to the first PRACH transmission comprising an indication of a selected beam of the plurality of beams, determining the selected beam based on the indication of the selected beam and based on transmission of the first PRACH transmission and one or more repetitions of the first PRACH transmission using the plurality of beams, and transmitting one or more message three (Msg3) transmissions to the network node using the selected beam.

### CROSS-REFERENCE TO RELATED APPLICATIONS

This application claims the benefit of U.S. Provisional Patent Application No. 63/377,596, entitled, “DETERMINATION OF A UE BEAM FOR MSG3 TRANSMISSION,” filed on Sep. 9, 2022, which is expressly incorporated by reference herein in its entirety.

### TECHNICAL FIELD

Aspects of the present disclosure relate generally to wireless communication systems, and more particularly, to beam selection for message 3 (Msg3) transmission. Some features may enable and provide improved communications, including determination of a UE beam for Msg3 transmission.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure a method of wireless communication includes transmitting, to a network node, a first physical random access channel (PRACH) transmission and one or more repetitions of the first PRACH transmission using a plurality of beams, receiving, from the network node, a response to the first PRACH transmission comprising an indication of a selected beam of the plurality of beams, determining the selected beam based on the indication of the selected beam and based on transmission of the first PRACH transmission and one or more repetitions of the first PRACH transmission using the plurality of beams, and transmitting one or more message three (Msg3) transmissions to the network node using the selected beam. In some embodiments the method may be performed by a UE.

In an additional aspect of the disclosure, an apparatus configured for wireless communication is disclosed. The apparatus includes at least one processor, and a memory coupled to the at least one processor. The apparatus may, for example, be a UE. The at least one processor is configured to transmit, to a network node, a first physical random access channel (PRACH) transmission and one or more repetitions of the first PRACH transmission using a plurality of beams, receive, from the network node, a response to the first PRACH transmission comprising an indication of a selected beam of the plurality of beams, determine the selected beam based on the indication of the selected beam and based on transmission of the first PRACH transmission and one or more repetitions of the first PRACH transmission using the plurality of beams, and transmit one or more message three (Msg3) transmissions to the network node using the selected beam.

In an additional aspect of the disclosure, an apparatus, such as a UE, configured for wireless communication is disclosed. The apparatus includes means for transmitting, to a network node, a first physical random access channel (PRACH) transmission and one or more repetitions of the first PRACH transmission using a plurality of beams, means for receiving, from the network node, a response to the first PRACH transmission comprising an indication of a selected beam of the plurality of beams, means for determining the selected beam based on the indication of the selected beam and based on transmission of the first PRACH transmission and one or more repetitions of the first PRACH transmission using the plurality of beams, and means for transmitting one or more message three (Msg3) transmissions to the network node using the selected beam.

In an additional aspect of the disclosure, a non-transitory computer-readable medium stores instructions that, when executed by a processor, such as a processor of a UE, cause the processor to perform operations including transmitting, to a network node, a first physical random access channel (PRACH) transmission and one or more repetitions of the first PRACH transmission using a plurality of beams, receiving, from the network node, a response to the first PRACH transmission comprising an indication of a selected beam of the plurality of beams, determining the selected beam based on the indication of the selected beam and based on transmission of the first PRACH transmission and one or more repetitions of the first PRACH transmission using the plurality of beams, and transmitting one or more message three (Msg3) transmissions to the second network node using the selected beam.

In another aspect of the disclosure, a method of wireless communication includes receiving, from a UE, a first physical random access channel (PRACH) transmission and one or more repetitions of the first PRACH transmission using a plurality of beams, selecting a beam of the plurality of beams, determining an indication of the selected beam of the plurality of beams based on receipt of the first PRACH transmission and the one or more repetitions of the first PRACH transmission using the plurality of beams, and transmitting, to the UE, a response to the first PRACH transmission comprising the determined indication of the selected beam of the plurality of beams. In some embodiments, the method may be performed by a network node, such as a base station.

In an additional aspect of the disclosure, an apparatus configured for wireless communication is disclosed. The apparatus includes at least one processor, and a memory coupled to the at least one processor. The apparatus may, for example, be a network node, such as a base station. The at least one processor is configured to receive, from a UE, a first physical random access channel (PRACH) transmission and one or more repetitions of the first PRACH transmission using a plurality of beams, select a beam of the plurality of beams, determine an indication of the selected beam of the plurality of beams based on receipt of the first PRACH transmission and the one or more repetitions of the first PRACH transmission using the plurality of beams, and transmit, to the UE, a response to the first PRACH transmission comprising the determined indication of the selected beam of the plurality of beams.

In an additional aspect of the disclosure, an apparatus, such as a network node, configured for wireless communication is disclosed. The apparatus includes means for receiving, from a UE, a first physical random access channel (PRACH) transmission and one or more repetitions of the first PRACH transmission using a plurality of beams, means for selecting a beam of the plurality of beams, means for determining an indication of the selected beam of the plurality of beams based on receipt of the first PRACH transmission and the one or more repetitions of the first PRACH transmission using the plurality of beams, and means for transmitting, to the UE, a response to the first PRACH transmission comprising the determined indication of the selected beam of the plurality of beams.

In an additional aspect of the disclosure, a non-transitory computer-readable medium stores instructions that, when executed by a processor, such as a processor of a network node, cause the processor to perform operations including receiving, from a UE, a first physical random access channel (PRACH) transmission and one or more repetitions of the first PRACH transmission using a plurality of beams, selecting a beam of the plurality of beams, determining an indication of the selected beam of the plurality of beams based on receipt of the first PRACH transmission and the one or more repetitions of the first PRACH transmission using the plurality of beams, and transmitting, to the UE, a response to the first PRACH transmission comprising the determined indication of the selected beam of the plurality of beams.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports determination of a UE beam for Msg3 transmission according to one or more aspects.

FIG. 4 is a timing diagram showing PRACH and Msg3 repetition using selected beams according to one or more aspects.

FIG. 5 is a flow diagram illustrating an example process that supports determination of a UE beam for Msg3 transmission according to one or more aspects.

FIG. 6 is a flow diagram illustrating an example process that supports determination of a UE beam for Msg3 transmission according to one or more aspects.

FIG. 7 is a block diagram of an example base station that supports determination of a UE beam for Msg3 transmission according to one or more aspects.

FIG. 8 is a block diagram of an example base station that supports determination of a UE beam for Msg3 transmission according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RAT s) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable transmission time interval (TTI) for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

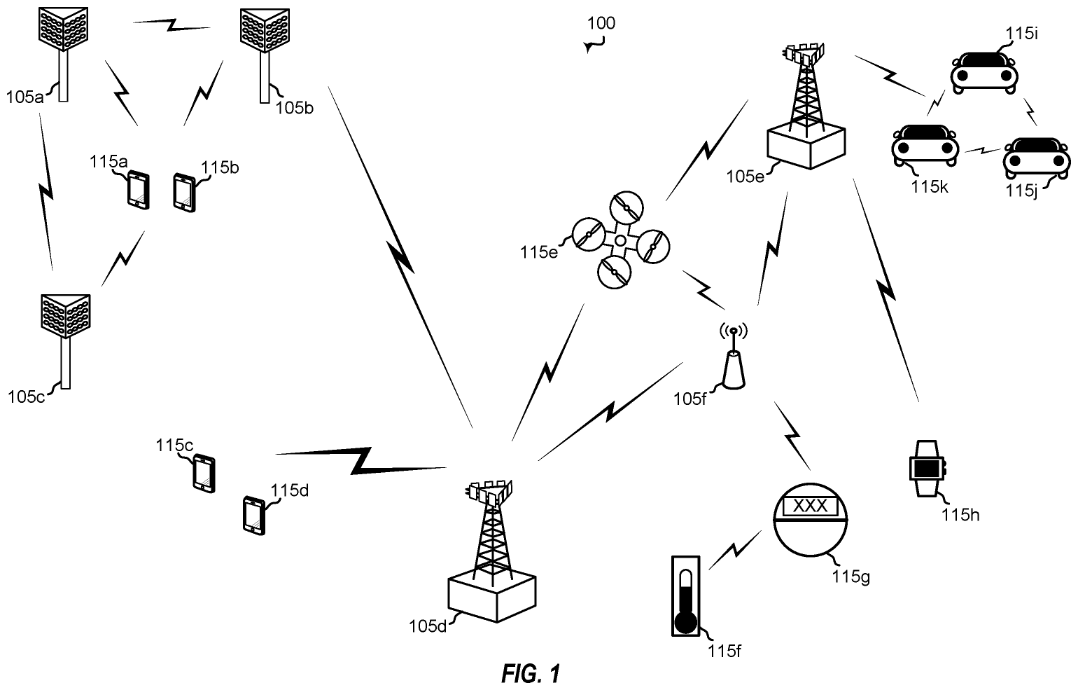

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

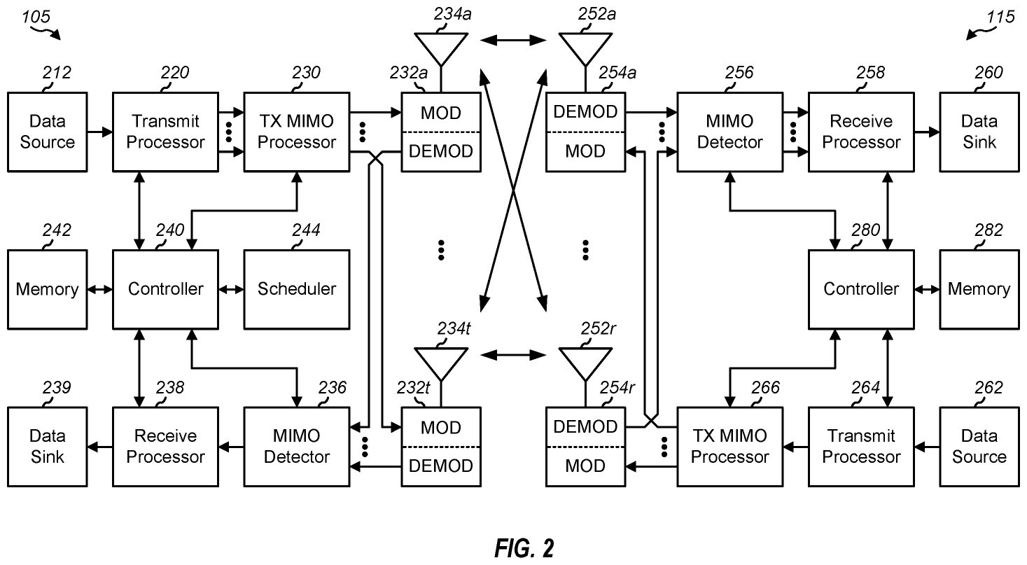

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

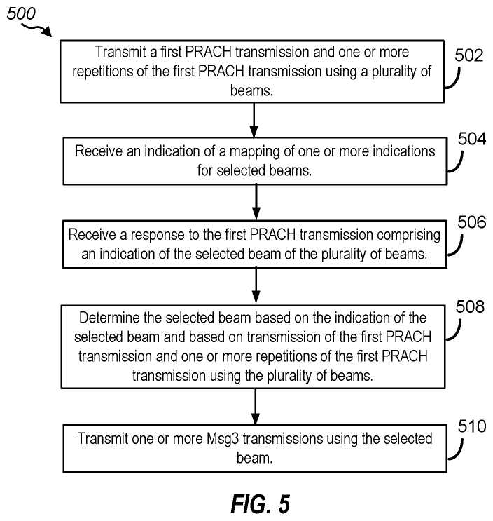

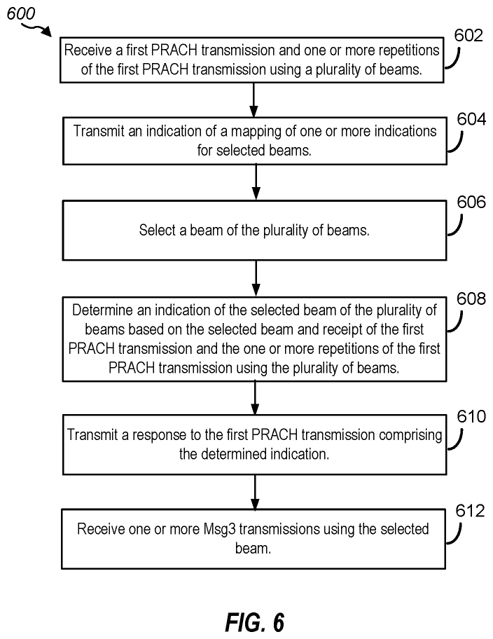

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 5-6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

A UE, which may be a network node, may transmit a physical random access channel (PRACH) transmission, such as a random access preamble or message one (Msg1) transmission, to one or more network nodes, such as one or more base stations. PRACH transmissions may be repeated one or more times to enhance reliability. For example, a first PRACH transmission may be repeated two, three, four, or more times. PRACH transmissions, such as a first PRACH transmission and one or more repetitions of the first PRACH transmission may be transmitted using different beams to further enhance reliability.

PRACH transmissions may be used to synchronize an uplink transmission. For example, in a contention-based random access channel (RACH) procedure, such as a four-step RACH procedure, a base station receiving one or more of the PRACH transmissions, such as one or more random access preambles or Msg1 transmissions, may respond to receipt of a PRACH transmission by transmitting a message two (Msg2) transmission, also referred to as a Msg2 response, to one or more of the PRACH transmissions to the transmitting UE. The Msg2 response may include a resource allocation for the UE to use in transmitting information to the base station. Upon receipt of the Msg2 response, the UE may transmit a message three (Msg3) transmission and one or more repetitions of the Msg3 transmission to the base station based on receipt of the Msg2 response. The repeated PRACH transmissions may allow a UE to synchronize with a base station for transmission of a scheduled uplink (UL) transmission, such as a Msg3 transmission. In some embodiments, the base station may also transmit a Msg2 physical downlink control channel (PDCCH) transmission, before transmitting the Msg2 response in response to receipt of a PRACH transmission, to provide the UE that transmitted the PRACH transmission with scheduling information for the Msg2 response. The Msg2 PDCCH transmission may include a random access radio network temporary identifier (RA-RNTI) for masking one or more Msg2 PDCCH transmissions, such as for masking a cyclic redundancy check (CRC) of the Msg2 PDCCH, and may be transmitted on one or more control channel elements (CCEs) of the control resources set (CORESET).

A UE may use multiple beams for transmission of a set of PRACH transmissions including a first PRACH transmission and one or more repetitions of the first PRACH transmission. For example, a UE may use a first beam for transmission of a first PRACH transmission and a second PRACH transmission, where the second PRACH transmission is a repetition of the first PRACH transmission. The UE may use a second beam, different from the first beam, for transmission of a third PRACH transmission and a fourth PRACH transmission, where third and fourth PRACH transmissions are repetitions of the first PRACH transmission.

Use of different beams for transmission of sets of PRACH transmissions may enhance reliability. For example, a first beam for transmitting a first set of PRACH transmissions may have a first beam direction, while a second beam for transmitting a second set of PRACH transmissions may have a second beam direction. The first beam having the first beam direction may, for example, have a first transmit control information (TCI) state or quasi-collocation (QCL) state, while the second beam having the second beam direction may have a second TCI state or QCL state different from the first TCI state or QCL state. Use of different beams may include use of different uplink spatial filtering configurations for PRACH transmissions.

The UE may use a selected beam of the beams used for transmission of a PRACH transmission and one or more repetitions of the PRACH transmission for transmission of subsequent associated Msg3 transmissions. For example, a base station may provide a UE with an indication of a selected beam of a plurality of beams used for transmission of the PRACH transmission and the one or more repetitions of the PRACH transmission, such as a best beam. The best beam may, for example, be determined by the base station based on a power or signal strength of the received PRACH transmission and repetitions. The UE may use the selected beam for transmission of a Msg3 transmission and repetitions of the Msg3 transmission. Use of a selected beam, such as a best beam, for transmission of a Msg3 transmission and one or more repetitions of the Msg3 transmission may provide enhanced reliability in reception of the Msg3 transmission and repetitions by the base station. For example, a beam that provides the greatest signal strength when receiving PRACH transmissions may also provide the greatest signal strength when receiving subsequent Msg3 transmissions. Furthermore, use of a selected beam for Msg3 transmission may enhance reliability of later uplink transmissions.

An indication of the selected beam may be transmitted in a Msg2 transmission or in a Msg2 PDCCH transmission. In some embodiments, bitfields of the Msg2 transmission that are used for indicating other parameters when multiple beams are not used for transmission of a PRACH transmission and repetitions of the PRACH transmission may be altered or repurposed to include the indication of the selected beam. For example, interpretation of bitfields may be adjusted such that one or more bitfields indicate a selected beam in addition to other information, without adding additional bits to the bitfields. In some embodiments, an additional bitfield may be added to the Msg2 transmission for indicating a selected beam, without changing a total number of bits in the Msg2 transmission. As one particular example, a bit of the Msg2 transmission that would be used to indicate a different parameter or would be otherwise reserved when the UE did not transmit a PRACH transmission and one or more repetitions of the PRACH transmission using different beams, may be repurposed for indication of a selected beam when the UE has used different beams for a PRACH transmission and one or more repetitions of the PRACH transmission. In some embodiments, the selected beam may be indicated by an RA-RNTI selected and used for the Msg2 PDCCH transmission or by one or more CCEs selected and used for the Msg2 PDCCH transmission. Such indication of the selected beam may enhance UE functionality by allowing a UE to receive and determine an indication of the selected beam while minimizing the complexity of such signaling.

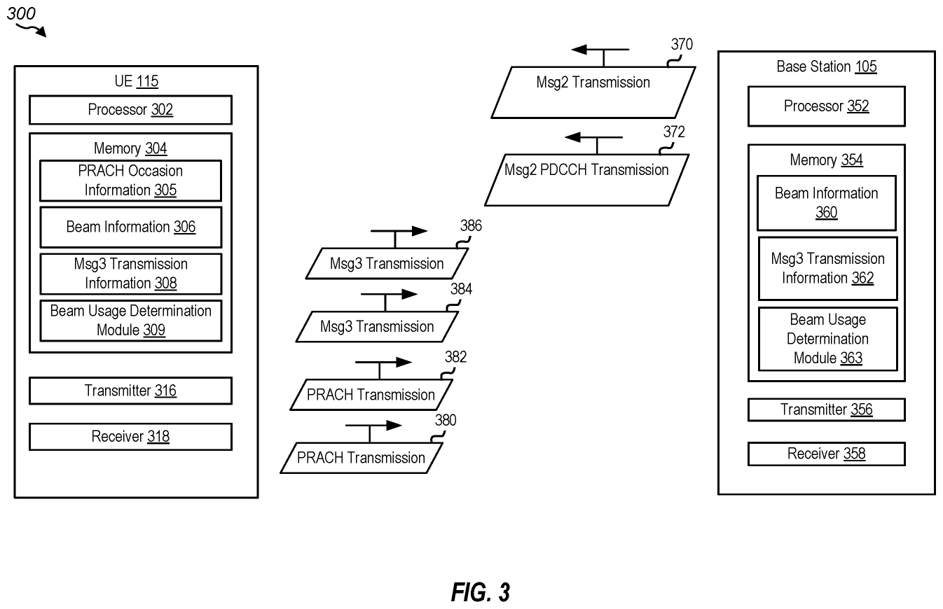

FIG. 3 is a block diagram of an example wireless communications system 300 that supports determination of a UE beam for Msg3 transmission according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store PRACH occasion information 305. PRACH occasion information 305 may, for example, include one or more times of one or more PRACH transmission occasions. For example, PRACH occasion information 305 may include one or more times of one or more PRACH transmission occasions for transmission of a PRACH transmission, such as a random access preamble or Msg1 transmission, and one or more repetitions of the PRACH transmission. Memory 304 includes or is configured to store beam information 306. Beam information 306 may, for example, include information indicating one or more beams to be used in transmitting a PRACH transmission, one or more repetitions of the PRACH transmission, a Msg3 transmission, or one or more repetitions of the Msg3 transmission. For example, beam information 306 may include information indicating a selected beam determined by the beam usage determination module 309 for use in transmitting a Msg3 transmission and one or more repetitions of the Msg3 transmission. The beam information 306 may, for example, include information regarding directions of one or more beams, such as TCI state information for one or more beams, QCL state information for one or more beams, uplink spatial filtering configurations for one or more beams, or other information for one or more beams. In some embodiments, beam information 306 may include information indicating which beams are used for transmitting PRACH transmissions and repetitions at particular PRACH occasions. In some embodiments, beam information 306 may include information indicating one or more PRACH opportunity (RO) bundles associated with particular respective beams. RO bundles may, for example, be sets of PRACH opportunities at which a PRACH transmission or one or more repetitions of the PRACH transmission are transmitted using a same beam. For example, if a PRACH transmission and one repetition of the PRACH transmission are transmitted using a same beam, the ROs at which the PRACH transmission and the repetition of the PRACH transmission are transmitted may form an RO bundle, and the RO bundle may be associated with a particular beam. Memory 304 includes or is configured to include Msg3 transmission information 308. Msg3 transmission information 308 may include information indicating timing information for a Msg3 transmission and one or more repetitions of the Msg3 transmission. For example, Msg3 transmission information 308 may include scheduling information for Msg3 transmissions received from the base station 105 in a Msg2 transmission 370. Memory 304 includes or is configured to include a beam usage determination module 309. The beam usage determination module 309 may include instructions for determining a selected beam for use in transmission of a Msg3 transmission and one or more repetitions of the Msg3 transmission, when the UE used a plurality of beams for transmission of an associated PRACH transmission and repetitions of the associated PRACH transmission. For example, the beam usage determination module 309 may include instructions for determining a selected beam for use in transmitting associated Msg3 transmissions based on an indication of the selected beam included in a received Msg2 transmission 370 or a received Msg2 PDCCH transmission 372.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store beam information 360. Beam information 360 may, for example, include information indicating one or more beams to be used in transmitting a PRACH transmission, one or more repetitions of the PRACH transmission, a Msg3 transmission, or one or more repetitions of the Msg3 transmission. For example, beam information 306 may include information indicating a selected beam determined by the beam usage determination module 363 for use in transmitting a Msg3 transmission and one or more repetitions of the Msg3 transmission, for transmission to UE 115. The beam information 360 may, for example, include information indicating directions of one or more beams, such as TCI state information for one or more beams, QCL state information for one or more beams, uplink spatial filtering configurations for one or more beams, or other information for one or more beams. In some embodiments, beam information 360 may include information indicating which beams are used for transmitting PRACH transmissions and repetitions at particular PRACH occasions by the UE 115. In some embodiments, beam information 360 may include information indicating one or more PRACH opportunity (RO) bundles of the UE 115 associated with particular beams. RO bundles may, for example, be sets of PRACH opportunities at which a PRACH transmission or one or more repetitions of the PRACH transmission are transmitted using a same beam. For example, if a PRACH transmission and one repetition of the PRACH transmission are transmitted using a same beam, the ROs at which the PRACH transmission and the repetition of the PRACH transmission are transmitted may form an RO bundle. Thus, beam information 360 of a base station 105 may include information indicating which transmissions of a PRACH transmission and one or more repetitions of the PRACH transmission are to be transmitted using specific beams, allowing the base station 105 to select a best beam, such as a beam having a greatest signal strength, from among the beams used for a PRACH transmission and repetitions. Memory 354 includes or is configured to include Msg3 transmission information 362. Msg3 transmission information 362 may, for example, include information regarding scheduling of one or more Msg3 transmissions to be transmitted by UE 115, which may be transmitted by the base station 105 in Msg2 transmission 370. Memory 354 includes or is configured to include a beam usage determination module 363. The beam usage determination module 363 may, for example, include instructions for determining a selected beam for use by the UE in transmitting one or more Msg3 transmissions and repetitions. For example, the beam usage determination module 363 may include instructions for determining a best beam used by the UE 115 in transmitting a PRACH transmission and one or more repetitions of the PRACH transmission to the base station 105, such as instructions for determining a beam with a greatest signal strength of the beams used to transmit the PRACH transmission and one or more repetitions of the PRACH transmission.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of the wireless communications system 300, the UE 115 may transmit a first PRACH transmission 380 using a first beam at a first PRACH occasion. The UE 115 may transmit a second PRACH transmission 382 using a second beam at a second PRACH occasion. The second PRACH transmission 382 may be a repetition of the first PRACH transmission 380. The base station 105 may receive the first PRACH transmission 380, transmitted using the first beam, and the second PRACH transmission, transmitted using the second beam. In some embodiments, the UE 115 may transmit and the base station 105 may receive PRACH transmissions and repetitions using more than two beams. The base station 105 may determine a selected beam of the beams used for transmission of the PRACH transmission and repetitions. For example, the base station 105 may determine a best beam based on a power of the received first PRACH transmission 380 and second PRACH transmission 382. In particular, the base station 105 may determine a best beam based on a comparison of received power of a PRACH transmission and one or more repetitions of the PRACH transmission using different beams to determine a beam of a PRACH transmission or repetition that was received with a greatest power.

The base station 105 may transmit a Msg2 transmission 370 including scheduling information for one or more Msg3 transmissions, associated with the first PRACH transmission 380 and the second PRACH transmission 382. For example, the Msg2 transmission 370 may include seven octets. A first bit of the first octet may be reserved. The remaining seven bits of the first octet may include part of a timing advance command value. The first five bits of the second octet may include the remainder of the timing advance command value. The remaining three bits of the second octet and the bits of the third, fourth, and fifth octets, may include UL grant information. The bits of the sixth and seventh octets may include a temporary cell radio network temporary identifier (C-RNTI) for the Msg3 transmission. Sets of bits of the Msg2 transmission that include particular information may be referred to as bitfields.

The uplink grant bitfield of the Msg2 transmission may indicate the resources to be used by the UE 115 for an associated Msg3 transmission and one or more repetitions of the Msg3 transmission and may be 27 bits long. A bitfield including a first bit of the uplink grant field of the Msg2 transmission 370 may include a frequency hopping flag. A value of zero of the frequency hopping flag may instruct the UE 115 to transmit the Msg3 transmissions without frequency hopping, while a value of one may instruct the UE 115 to transmit the Msg3 transmissions with frequency hopping. A bitfield including the next fourteen bits of the uplink grant field may indicate frequency resources for transmission of the Msg3 transmission and repetitions, and may be referred to as a frequency domain resource allocation bitfield. A bitfield including the four bits of the uplink grant field following the frequency resource indication may indicate time resources for transmission of the Msg3 transmission and repetitions and may be referred to as a time domain resource allocation bitfield. A bitfield including the four bits of the uplink grant bitfield following the time resource indication may include an indication of a modulation and coding scheme to be used in transmission of the Msg3 transmission and repetitions and may be referred to as a modulation and coding scheme bitfield. A bitfield including the three bits of the uplink grant field following the modulation and coding scheme indication may indicate a transmit power command (TPC) value used for setting a power of the Msg3 transmission and repetitions and may be referred to as a TPC bitfield. The bitfield including the final bit of the uplink grant field may be reserved for a channel state information (CSI) request indication and may be referred to as a reserved bitfield.

Use of the fields of the Msg2 transmission 370 may be adjusted when a PRACH transmission and repetitions are received by the base station 105 on different beams to indicate a selected beam. For example, the UE 115 may be configured to interpret one or more fields of the Msg2 transmission differently when using multiple beams for transmission of a PRACH transmission and one or more repetitions of the PRACH transmission in order to determine a selected beam indicated by the base station 105. Likewise, the base station 105 may be configured to determine values for the bitfields of the Msg2 transmission differently when responding to a PRACH transmission and one or more repetitions for which different beams were used. In some embodiments, the base station may include an indication of a selected beam in the TPC bitfield. For example, a first two bits of the TPC bitfield may indicate a selected TPC value, while a final bit of the TPC bitfield may indicate a selected beam of two beams used for transmission of the PRACH transmission and repetitions. As another example, a first bit of the TPC bitfield may indicate a selected beam, while the final two bits of the TPC bitfield may indicate a TPC value. As another example, one or more bits of the frequency domain resource allocation bitfield may be used to indicate a selected beam. As one example, a new column may be added to a frequency domain resource allocation lookup table indicating values of a bit of the frequency domain resource allocation bitfield that correspond to a particular selected beam. For example, a first value of the bit may correspond to a first RO set of PRACH transmissions transmitted using a first beam, while a second value of the bit may correspond to a second RO set of PRACH transmissions using a second beam. In particular, an index of a starting reference bit of the frequency domain resource allocation bitfield may be linked to a beam used for Msg3 transmission and repetitions or a reference number of the beam. Such a lookup table may be used by the UE 115 to determine a selected beam and by the base station 105 to determine an indication of the selected beam. As one particular example, a modulo operation with a set coefficient, modulo base, or offset, such as a·x+b mod(C) may be used to determine a bit value for indication of the selected reference block. As another example, one or two most significant bits or least significant bits of the frequency domain resource allocation bitfield may be used to indicate the selected beam. As another example, one or more bits of the modulation and coding scheme bitfield or the reserved bitfield may be used to indicate the selected beam. As another example, the bitfield of the Msg2 transmission 370 including the temporary C-RNTI may indicate the selected beam. For example, the bitfield may indicate the selected beam based on a modulo operation rule. In some embodiments, one or more bits of the C-RNTI bitfield may be used to indicate the selected beam. Such use of the temporary C-RNTI bitfield may, however, reduce the number of available temporary C-RNTIs for assignment to UEs. Thus, bitfields of the Msg2 transmission 370 may be repurposed for indication of the selected beam. Such bitfields may be repurposed by the base station 105 contingent on receipt of a PRACH transmission and one or more repetitions of the PRACH transmission using different beams or contingent upon receipt of an indication that the UE will use multiple beams for transmission of a PRACH transmission and one or more repetitions of the PRACH transmission. Thus, if the base station 105 receives a PRACH transmission and repetitions of the PRACH transmission using a single beam, the base station 105 may not adjust the bitfields of the Msg2 transmission 370 to include an indication of a selected beam. The correspondence of specific beams to specific indicator bits of specific bitfields may be included in the beam information 360 and the beam information 306.

In some embodiments, the base station 105 may transmit a Msg2 PDCCH transmission 372 to the UE 115 in response to the received first PRACH transmission 380 and second PRACH transmission 382. The Msg2 PDCCH transmission 372 may include information indicating scheduling of the Msg2 transmission 370. The Msg2 PDCCH transmission 372 may further include an indication of a selected beam of a plurality of beams used for transmission of associated PRACH transmissions. As one example, the selected beam may be indicated by a specific RA-RNTI, such as an RA-RNTI for masking of a Msg2 PDCCH. For example, the base station 105 and UE 115 may include a lookup table of RA-RNTIs that correspond to specific selected beams, such as specific RO sets or bundles transmitted using specific beams. As another example, the selected beam may be indicated by a location of CCEs of the Msg2 PDCCH transmission 372 within the CORESET. For example, the selected beam may be indicated by an index of a first CCE of the Msg2 PDCCH transmission 372. In some embodiments, a mapping of CCE indexes of Msg2 PDCCH transmissions to beams used for transmission of PRACH transmissions, such as to particular RO bundles transmitted using particular beams, may be configured in system information, such as remaining minimum system information or other system information, received by the UE 115 in a system information block transmission. Likewise, indications of specific bit values or specific RA-RNTIs that correspond to specific beams or RO bundles associated with specific beams may be transmitted by the base station 105 and received by the UE 115. The indications of selected beams described herein may be used by the base station 105 contingent on receipt of a PRACH transmission and one or more repetitions of the PRACH transmission or contingent on receipt of an indication that the UE 115 is configured to transmit a PRACH transmission and one or more repetitions of the PRACH transmission using a plurality of beams. In some embodiments, use of such indications by the base station 105 may be contingent on receipt of a PRACH transmission and one or more repetitions of the PRACH transmission using different beams. Thus, if the base station 105 receives a PRACH transmission and repetitions of the PRACH transmission using a single beam, the base station 105 may not indicate a selected beam. The correspondence of specific beams to RA-RNTIs or CCEs of Msg2 PDCCH transmissions may be included in the beam information 360 and the beam information 306.

The UE 115 may receive the Msg2 transmission 370 or the Msg2 PDCCH transmission 372 indicating the beam selected by the base station 105. The UE 115 may determine an indication of the selected beam based on beam information 306 which may include information indicating how the selected beam will be indicated by the base station 105, such as in a particular bitfield of the Msg2 transmission 370, by a particular parameter of the Msg2 PDCCH transmission 372, or otherwise. For example, the UE 115 may use one or more lookup tables of the beam information 306 to determine which beam a particular bit value of the Msg2 transmission 370, a particular RA-RNTI of the Msg2 PDCCH transmission 372, or a particular first CCE of the Msg2 PDCCH transmission 372 corresponds to. Such operations may, for example, be performed by the beam usage determination module 309. The UE 115 may then transmit a first Msg3 transmission 384 and a second Msg3 transmission 386 using the selected beam. The second Msg3 transmission 386 may be a repetition of the first Msg3 transmission 384.

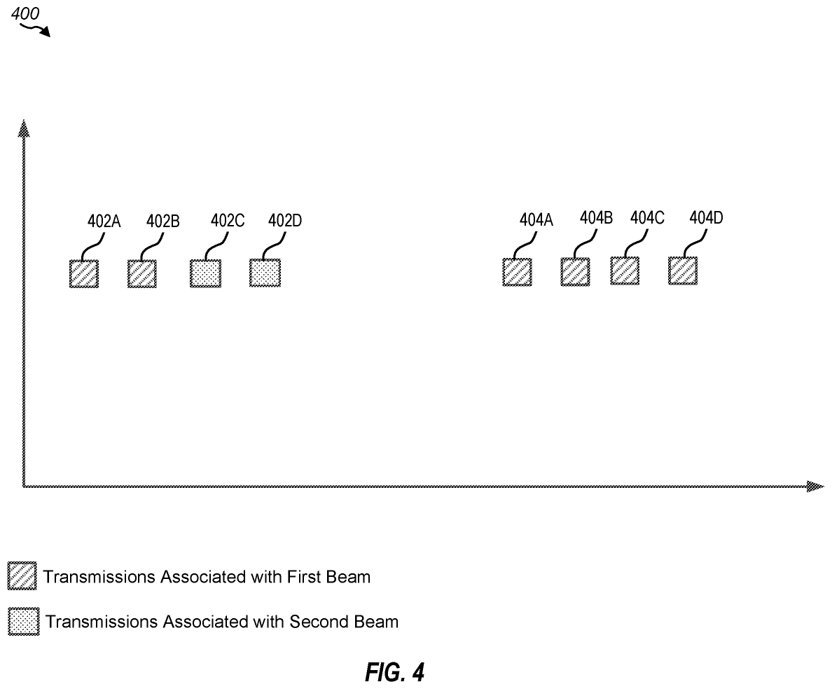

A UE that is configured to transmit multiple PRACH transmissions, such as a first PRACH transmission and one or more repetitions of the first PRACH transmission, may transmit the multiple PRACH transmissions using multiple beams. The UE may also transmit one or more Msg3 transmissions, such as a first Msg3 transmission and one or more repetitions of the first Msg3 transmission, using a selected beam of the multiple beams determined based on a received indication of the selected beam. For example, if multiple beams are used, by the UE, for transmission of a PRACH transmission and one or more repetitions of the PRACH transmission, a receiving base station may select a beam of the multiple beams and may determine an indication of the selected beam based on receipt of the PRACH transmission and one or more repetitions of the PRACH transmission using multiple beams. That is, selection of a beam of the multiple beams or determination of an indication of the selected beam may be contingent on receipt of a PRACH transmission and one or more repetitions of the PRACH transmission using multiple beams. The base station may then transmit a response including the determined indication to the UE. The UE may receive the response, may determine the selected beam, and may transmit one or more Msg3 transmissions using the selected beam. The determination of the selected beam by the UE may be contingent upon use of multiple beams for transmission of an associated PRACH transmission and one or more repetitions of the associated PRACH transmission. An example time/frequency plot 400 of multiple PRACH transmissions 402A-D and Msg3 transmissions 406A-D is shown in FIG. 4.

A UE may transmit a first PRACH transmission 402A and a second PRACH transmission 402B using a first beam. The UE may determine to use the first beam for transmission of the first PRACH transmission 402A and the second PRACH transmission 402B based on PRACH transmission occasions at which the first PRACH transmission 402A and the second PRACH transmission 402B are transmitted. The UE may further transmit a third PRACH transmission 402C and a fourth PRACH transmission 402D using a second beam. The UE may determine to use the second beam for transmission of the third PRACH transmission 402C and the fourth PRACH transmission 402D based on PRACH transmission occasions at which the third PRACH transmission 402C and the fourth PRACH transmission 402D are transmitted. The second PRACH transmission 402B, the third PRACH transmission 402C, and the fourth PRACH transmission 402D may be repetitions of the first PRACH transmission 402A, including the same or similar information. In some embodiments, fewer or more than two PRACH transmissions or repetitions may be transmitted using the same beam. In some embodiments, fewer than or more than three repetitions of the same PRACH transmission may be transmitted. In some embodiments, more than two beams may be used for PRACH transmissions. PRACH transmissions occasions at which PRACH transmissions are transmitted using a same beam and including the same or similar information, such as PRACH transmissions 402A and 402B or PRACH transmissions 402C and 402D, may be referred to as PRACH opportunity bundles or RO bundles. Thus, a set of PRACH transmissions including a first PRACH transmission and one or more repetitions of the first PRACH transmission may be transmitted using a plurality of beams based on time periods in which the PRACH transmissions are transmitted.

A selected beam of the beams used for transmission of a PRACH transmission 402A and repetitions 402B-D of the PRACH transmission 402A may be used for transmission of an associated Msg3 transmission 404A and repetitions 404B-D of the Msg3 transmission. For example, a UE may receive a response to the PRACH transmissions 402A-D from a base station including an indication of a beam of the beams used for transmission of the PRACH transmissions 402A-D and may determine a beam for use in transmission of the Msg3 transmissions 404A-D associated with the PRACH transmissions 402A-D based on the indication. For example, as shown in FIG. 4, the first beam may be selected by the base station, although in operation the second beam, or another beam, may be selected by the base station. The UE may receive a response, such as a Msg2 transmission or a Msg2 PDCCH transmission, including an indication that the first beam is selected. The UE may determine selection of the first beam based on the received indication and may transmit the associated Msg3 transmission 404A and repetitions 404B-D of the associated Msg3 transmission using the first beam. The Msg3 transmission 404A and repetitions 404B-D may be associated with the PRACH transmission 402A and repetitions 402B-D in that they may be scheduled by a Msg2 transmission transmitted by a base station in response to the PRACH transmission 402A and repetitions 402B-D. In some embodiments, fewer or more than three repetitions of a Msg3 transmission 404A may be transmitted. Although shown as being transmitted on the same frequency resources, in some embodiments PRACH transmissions 402A-D and Msg3 transmissions 406A-D may be transmitted on different frequency resources. Thus, a UE may use different beams for transmission of PRACH transmissions and may use a selected beam of the different beams for transmission of associated Msg3 transmissions.

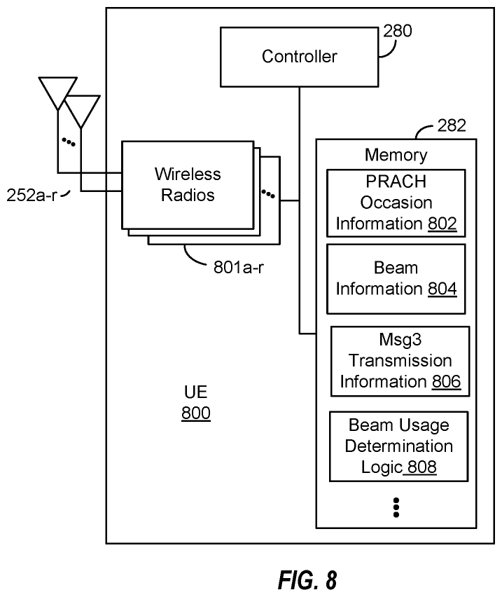

A UE may use a selected beam, of multiple beams used for transmission of a PRACH transmission and one or more repetitions of the PRACH transmission, for transmission of one or more associated Msg3 transmissions. FIG. 5 is a flow diagram illustrating an example process 500 that supports determination of a UE beam for Msg3 transmission according to one or more aspects. Operations of process 500 may be performed by a UE, such as UE 115 described above with reference to FIGS. 1, 2, 3, or a UE described with reference to FIG. 8. For example, example operations (also referred to as “blocks”) of process 500 may enable UE 115 to support determination of a UE beam for Msg3 transmission.

At block 502, the UE may transmit a first PRACH transmission and one or more repetitions of the first PRACH transmission. The first PRACH transmission and one or more repetitions of the first PRACH transmission may be transmitted using a plurality of beams. For example, the first PRACH transmission and a first repetition of the first PRACH transmission may be transmitted at PRACH opportunities of a first RO bundle using a first beam, while second and third repetitions of the first PRACH transmission may be transmitted at PRACH opportunities of a second RO bundle using a second beam. In some embodiments, more than two beams may be used for transmission of a PRACH transmission and repetitions of the PRACH transmission.

At block 504, the UE may receive an indication of a mapping of one or more beam selection indications. The mapping of the beam selection indications may be received in remaining minimum system information (RMSI) of a system information block one (SIB1) transmission or in other system information. The mapping may, for example, include information indicating how the UE should determine a selected beam based on receipt of a response to the PRACH transmission and one or more repetitions from a base station. For example, the mapping may include an indication of a specific bit in a specific bit field that indicates which beam of a plurality of beams should be used for transmission of a PRACH transmission. As another example, the mapping may include an indication of one or more rules for determining a selected beam, such as rules based on one or more modulo operations with preconfigured coefficients, modulo bases, or offsets, or rules based on use of one or more most significant bits or least significant bits of a bitfield to determine the selected beam. As another example, the mapping may include a modified table, such as frequency domain resource allocation table including an additional column for a particular bit indicating which values of the bit correspond to specific beams or specific RO bundles at which PRACH transmissions are transmitted using a specific beam. As another example, the mapping may include an indication of RA-RNTIs of a Msg2 PDCCH transmission that correspond to specific beams or RO bundles associated with specific beams or an indication of locations of CCEs of a Msg2 PDCCH transmission that correspond to specific beams or RO bundles associated with specific beams. For example, the mapping may include a mapping of indexes of a first CCE of a Msg2 PDCCH transmission to specific beams or RO bundles associated with specific beams. Thus, in some embodiments, the UE may receive a mapping of beam selection indications to specific beams.

At block 506, the UE may receive a response to the first PRACH transmission comprising an indication of the selected beam of the plurality of beams. The response may, for example, be a Msg2 transmission or a Msg2 PDCCH transmission transmitted by a base station in response to the first PRACH transmission and repetitions. In some embodiments, the indication may comprise a first bitfield, such as a first bitfield of the Msg2 transmission. In some embodiments, the first bitfield may, for example, be a bitfield used for indicating a particular type of information when a single beam is used for transmission of a PRACH transmission and one or more PRACH repetitions. In some embodiments, the bitfield may be used to indicate the same information, but may also be used to indicate the selected beam, such as through a different interpretation of one or more bits of the bitfield. For example, the first bitfield may be a first bitfield of a PDCCH transmission, such as a first bitfield of a UL grant bitfield of the Msg2 PDCCH transmission or a temporary C-RNTI bitfield of the Msg2 PDCCH transmission. As one example, the indication of the selected beam may be one or more bits of a transmit power control (TPC) bitfield that includes transmit power control information when PRACH transmissions and repetitions are transmitted using a same beam. As another example, the indication of the selected beam may be one or more bits of a frequency domain resource allocation bitfield that includes frequency domain resource allocation information when PRACH transmissions and repetitions are transmitted using a same beam. Such a bitfield may, for example, be interpreted by the UE, as discussed below with respect to block 508, based on a frequency domain resource allocation table including an additional column for one or more bits of the bitfield designated for indication of a selected beam. For example, particular bit values of the frequency domain resource allocation bitfield may be assigned to particular beams or RO groups based on one or more rules, such as a modulo operation with a preconfigured coefficient, modulo base, or offset, or based on use of one or more most significant bits or least significant bits of the frequency domain resource allocation bitfield. As another example, the indication of the selected beam may include one or more bits of a modulation and coding scheme (MCS) bitfield of a UL grant bitfield of the Msg2 transmission. For example, values of one or more bits of the MCS bitfield may be assigned to particular beams or particular RO groups associated with particular beams. As another example, values of a reserved bit of the UL grant bitfield of the Msg2 transmission may be assigned to particular beams or particular RO groups associated with particular beams. As another example, one or more bits of a temporary C-RNTI bitfield of the Msg2 transmission may be assigned to particular beams or particular RO groups associated with particular beams, such as through a modulo operation rule. In some embodiments, the indication may comprise an RA-RNTI of a Msg2 PDCCH transmission. For example, one or more possible RA-RNTI's of the Msg2 PDCCH transmission, such as one or more RA-RNTIs for masking a Msg2 PDCCH transmission, may be mapped to particular beams or particular RO groups. Inclusion of a particular RA-RNTI in the Msg2 PDCCH transmission may indicate a particular beam or a particular RO group associated with a particular beam. In some embodiments, the indication may comprise one or more locations of one or more CCEs of the Msg2 PDCCH transmission inside the CORESET of the Msg2 PDCCH transmission. For example, particular beams or multiple RO groups associated with particular beams may be mapped to indexes of potential first CCEs of the Msg2 PDCCH transmission. Thus, in some embodiments the selected beam may be indicated by a location of a first CCE, or by an index of a location of a first CCE, of the Msg2 PDCCH transmission. Thus, when multiple beams are used for a PRACH transmission, interpretation of certain bitfields or parameters of a response transmitted by a base station may be adjusted to accommodate an indication of a selected beam.

At block 508, the UE may determine the selected beam based on the indication of the selected beam and based on transmission of the first PRACH transmission and one or more repetitions of the first PRACH transmission using the plurality of beams. For example, determination of a selected beam may be contingent upon transmission of a PRACH transmission and one or more repetitions of the PRACH transmission using different beams. In particular, different bitfields or aspects, such as an RA-RNTI or locations of CCEs, of a response may be interpreted differently, such as to indicate a selected beam or not to indicate a selected beam, based on whether the UE transmitted the PRACH transmission and one or more repetitions of the PRACH transmission using a single beam or multiple beams. Further, a selected beam may be determined based the UE's knowledge of the beams that were used to transmit the PRACH transmission and one or more repetitions of the PRACH transmission. In some aspects, a UE may take action to determine a selected beam based on a Msg2 PDCCH or Msg2 transmission based on the prior transmission, by the UE, of the first PRACH transmission and one or more repetitions of the first PRACH transmission using different beams. Thus, determination of the selected beam may be based, at least in part, on the one or more repetitions of the first PRACH transmission using the plurality of beams. Thus, the UE may determine a selected beam based on the received indication and transmission of the first PRACH transmission and one or more repetitions of the first PRACH transmission using the plurality of beams. As one example, the UE may compare the received indication bit with a look up table to determine a beam to which the indication corresponds. In some embodiments, the UE may determine an RO group based on the received indication and may determine a beam associated with the RO group. The beam associated with the RO group may be the selected beam. The UE may use the received indication of the mapping described with respect to block 504 to determine the selected beam. For example, the UE may determine that a particular indication of a Msg2 transmission or Msg2 PDCCH transmission, such as a particular value of a particular bitfield, a particular RA-RNTI, or a particular CCE or set of CCEs used, corresponds to a particular selected beam.

At block 510, the UE may transmit one or more Msg3 transmissions using the selected beam. For example, the UE may transmit a first Msg3 transmission and one or more repetitions of the first Msg3 transmission, associated with the first PRACH transmission and repetitions of the first PRACH transmission, using the selected beam. The Msg3 transmissions may, for example, be physical uplink shared channel (PUSCH) transmissions transmitted using resources allocated by a Msg2 transmission. Thus, the UE may use a selected beam of a plurality of beams used for transmission of a PRACH transmission and one or more repetitions of the PRACH transmission for transmission of associated Msg3 transmissions.

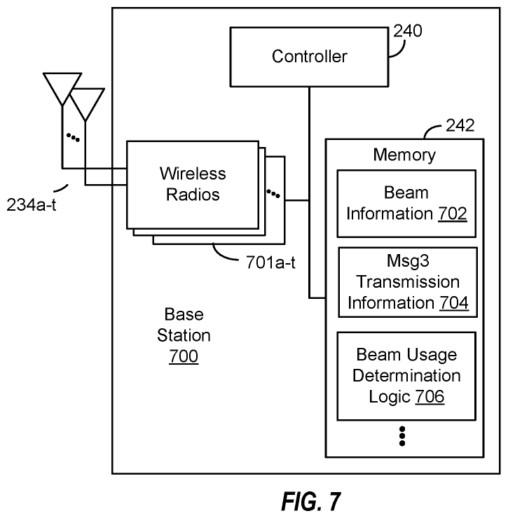

FIG. 6 is a flow diagram illustrating an example process 600 that supports determination of a UE beam for Msg3 transmission according to one or more aspects. Operations of process 600 may be performed by a base station, such as base station 105 described above with reference to FIGS. 1-3 or a base station as described below with reference to FIG. 7. For example, example operations of process 600 may enable base station 105 to support determination of a UE beam for Msg3 transmission.

At block 602, the base station may receive a first PRACH transmission and one or more repetitions of the first PRACH transmission using a plurality of beams. For example, the base station may receive a first PRACH transmission and one or more repetitions of the first PRACH transmissions transmitted by a UE as described with respect to block 502 of FIG. 5. The first PRACH transmission and one or more repetitions of the first PRACH transmission may, for example, be transmitted using two, or more, respective beams. The first PRACH transmission may, for example, be a random access preamble transmission or a Msg1 transmission.

At block 604, the base station may transmit an indication of a mapping of one or more beam selection indications. The indication of the mapping may, for example, be an indication of a mapping as described with respect to block 504 of FIG. 5.

At block 606, the base station may select a beam of the plurality of beams used for transmission of the first PRACH transmission and one or more repetitions of the first PRACH transmission to be used by the UE for transmission of one or more Msg3 transmissions associated with the first PRACH transmission and one or more repetitions of the first PRACH transmission. In some embodiments, the selected beam may be a best beam. For example, the base station may measure a signal strength of PRACH transmissions transmitted using different beams and may determine a beam associated with a greatest signal strength. For example, the base station may store information indicating one or more PRACH opportunities, such as one or more ROs, for transmission of PRACH transmissions, such as a first PRACH transmission or one or more repetitions of the first PRACH transmission, using a same beam. The base station may thus determine that PRACH transmissions transmitted at particular PRACH occasions are transmitted using particular beams and may determine a best beam based on measurement of PRACH transmissions transmitted using particular beams. For example, the base station may measure all PRACH transmissions of a set including a first PRACH transmission and one or more repetitions of the first PRACH transmission transmitted at PRACH opportunities of a first RO bundle associated with a first beam and may measure all PRACH transmissions of the set transmitted at PRACH opportunities of a second RO bundle associated with a second beam and may determine the beam associated with a greatest average signal strength based on the measurements. Thus, the base station may select a beam of multiple beams used for transmission of a PRACH transmission and one or more repetitions of the PRACH transmission.

At block 608, the base station may determine an indication of the selected beam of the plurality of beams based the selected beam and on receipt of the first PRACH transmission and the one or more repetitions of the first PRACH transmission using the plurality of beams. For example, determination of the indication of the selected beam may be contingent on receipt of a PRACH transmission and one or more repetitions of the PRACH transmission using a plurality of beams. As another example, determination of the indication of the selected beam may be contingent on receipt of an indication that the PRACH transmission and repetitions of the PRACH transmission will be transmitted using a plurality of beams. The determined indication may, for example, comprise a first bitfield of a response to the PRACH transmission and repetitions, such as a first bitfield of a Msg2 response. As described with respect to block 506 of FIG. 5, a variety of different bits of different bitfields may be available for selection for use as an indication of the selected beam. For example, the first bitfield may be designated, when a PRACH transmission and repetitions of the PRACH transmission are transmitted using a single beam, for transmission of transmit power control information, frequency domain resource allocation information, modulation and coding scheme information, C-RNTI information, or reserved bitfield information. In some embodiments, the first bitfield may include such information in addition to the indication of the selected beam. For example, one or more bits of one or more such bitfields may be repurposed for transmission of the indication of the selected beam as described with respect to block 506 of FIG. 5, while the bitfield also transmits other information. A first bit value of one or more bits of the bitfield may, for example, be mapped to a first beam or a first RO bundle associated with a first beam, while a second bit value of one or more bits of the bitfield may be mapped to a second beam or a second RO bundle associated with the second beam. As another example, the indication of the selected beam may comprise an RA-RNTI of a Msg2 PDCCH transmission or a location of one or more CCEs of the Msg2 PDCCH transmission inside a CORESET of the Msg2 PDCCH transmission, as described with respect to block 506 of FIG. 5. In some embodiments, the base station may be configured to use one of the potential indications of the selected beam discussed herein for indication of the selected beam and may determine the indication of the selected beam based on the configuration, the selected beam, and receipt of the PRACH transmission and one or more repetitions of the PRACH transmission using the selected beam.

At block 610, the base station may transmit a response to the first PRACH transmission comprising the determined indication. The response may, for example, include a Msg2 transmission or a Msg2 PDCCH transmission, depending on the determined indication. The transmitted response may, for example, be a response as described with respect to block 506 of FIG. 5. The response may also include scheduling information for one or more Msg3 transmissions to be transmitted by the receiving UE.

At block 612, the base station may receive one or more Msg3 transmissions using the selected beam. For example, the base station may receive a Msg3 transmission and one or more repetitions of the Msg3 transmission, associated with the first PRACH transmission and repetitions, transmitted by the UE as described with respect to block 510 of FIG. 5. Thus, a base station may transmit an indication of a selected beam of a plurality of beams used for transmission of a PRACH transmission and one or more repetitions of the PRACH transmission to be used by a UE for transmission of one or more associated Msg3 transmissions.

FIG. 7 is a block diagram of an example base station 700 that supports determination of a UE beam for Msg3 transmission according to one or more aspects. Base station 700 may be configured to perform operations, including the blocks of process 600 described with reference to FIG. 6. In some implementations, base station 700 includes the structure, hardware, and components shown and described with reference to base station 105 of FIGS. 1-3. For example, base station 700 may include controller 240, which operates to execute logic or computer instructions stored in memory 242, as well as controlling the components of base station 700 that provide the features and functionality of base station 700. Base station 700, under control of controller 240, transmits and receives signals via wireless radios 701a-t and antennas 234a-t. Wireless radios 701a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include beam information 702, Msg3 transmission information 704, and beam usage determination logic 706. Beam information 702 may, for example, include information indicating one or more beams to be used in transmitting a PRACH transmission, one or more repetitions of the PRACH transmission, a Msg3 transmission, or one or more repetitions of the Msg3 transmission. For example, beam information 702 may include information indicating a selected beam determined by the beam usage determination logic 706 for use in transmitting a Msg3 transmission and one or more repetitions of the Msg3 transmission to UE 800. The beam information 702 may, for example, include information indicating directions of one or more beams, such as TCI state information for one or more beams, QCL state information for one or more beams, uplink spatial filtering configurations for one or more beams, or other information for one or more beams. In some embodiments, beam information 702 may include information indicating which beams should be used for transmitting PRACH transmissions and repetitions at particular PRACH occasions. In some embodiments, beam information 702 may include information indicating one or more PRACH opportunity (RO) bundles. RO bundles may, for example, be sets of PRACH opportunities at which a PRACH transmission or one or more repetitions of the PRACH transmission are transmitted using a same beam. For example, if a PRACH transmission and one repetition of the PRACH transmission are transmitted using a same beam, the ROs at which the PRACH transmission and the repetition of the PRACH transmission are transmitted may form an RO bundle. Thus, beam information 702 of a base station 700 may include information indicating which transmissions of a PRACH transmission and one or more repetitions of the PRACH transmission are to be transmitted using specific beams, allowing the base station 700 to select a best beam, such as a beam having a greatest signal strength. Msg3 transmission information 704 may, for example, include information regarding scheduling of one or more Msg3 transmissions to be transmitted by UE 800, which may be transmitted by the base station 700 in a Msg2 transmission. Beam usage determination logic 706 may, for example, be configured to determine a selected beam for use by the UE in transmitting one or more Msg3 transmissions and repetitions. For example, the beam usage determination logic 706 may be configured to determine a best beam of a plurality of beams used by the UE 800 in transmitting a PRACH transmission and one or more repetitions of the PRACH transmission to the base station 700. In particular, the beam usage determination logic 706 may be configured to determine a beam with a greatest signal strength used to transmit the PRACH transmission and one or more repetitions of the PRACH transmission. Base station 700 may receive signals from or transmit signals to one or more UEs, such as UE 115 of FIGS. 1-3 or UE 800 of FIG. 8.

FIG. 8 is a block diagram of an example UE 800 that supports determination of a UE beam for Msg3 transmission according to one or more aspects. UE 800 may be configured to perform operations, including the blocks of a process described with reference to FIG. 5. In some implementations, UE 800 includes the structure, hardware, and components shown and described with reference to UE 115 of FIGS. 1-3. For example, UE 800 includes controller 280, which operates to execute logic or computer instructions stored in memory 282, as well as controlling the components of UE 800 that provide the features and functionality of UE 800. UE 800, under control of controller 280, transmits and receives signals via wireless radios 801a-r and antennas 252a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include PRACH occasion information 802, beam information 804, Msg3 transmission information 806, and beam usage determination logic 808. PRACH occasion information 802 may, for example, include one or more times of one or more PRACH transmission occasions. For example, PRACH occasion information 802 may include one or more times of one or more PRACH transmission occasions for transmission of a PRACH transmission, such as a random access preamble or Msg1 transmission, and one or more repetitions of the PRACH transmission. Beam information 804 may, for example, include information indicating one or more beams to be used in transmitting a PRACH transmission, one or more repetitions of the PRACH transmission, a Msg3 transmission, or one or more repetitions of the Msg3 transmission. For example, beam information 804 may include information indicating a selected beam determined by the beam usage determination logic 808 for use in transmitting a Msg3 transmission and one or more repetitions of the Msg3 transmission. The beam information 804 may, for example, include information regarding directions of one or more beams, such as TCI state information for one or more beams, QCL state information for one or more beams, uplink spatial filtering configurations for one or more beams, or other information for one or more beams. In some embodiments, beam information 804 may include information indicating which beams should be used for transmitting PRACH transmissions and repetitions at particular PRACH occasions. In some embodiments, beam information 804 may include information indicating one or more RO bundles and beams associated with the respective RO bundles. Msg3 transmission information 806 may include information indicating timing information for a Msg3 transmission and one or more repetitions of the Msg3 transmission. For example, Msg3 transmission information 806 may include scheduling information for Msg3 transmissions received from the base station 700 in a Msg2 transmission. Beam usage determination logic 808 may determine a selected beam for use in transmission of a Msg3 transmission and one or more repetitions of the Msg3 transmission, when the UE 800 used a plurality of beams for transmission of an associated PRACH transmission and repetitions of the associated PRACH transmission. For example, the beam usage determination logic 808 may determine a selected beam for use in transmitting associated Msg3 transmissions based on an indication included in a received Msg2 transmission or a received Msg2 PDCCH transmission. UE 800 may receive signals from or transmit signals to one or more network entities, such as base station 105 of FIGS. 1-3 or a base station 700 as illustrated in FIG. 7.

It is noted that one or more blocks (or operations) described with reference to FIGS. 5-6 may be combined with one or more blocks (or operations) described with reference to another of the figures. For example, one or more blocks (or operations) of FIG. 5 may be combined with one or more blocks (or operations) of FIG. 6. As another example, one or more blocks associated with FIG. 3 may be combined with one or more blocks associated with FIG. 5. As another example, one or more blocks associated with FIG. 3 may be combined with one or more blocks (or operations) associated with FIGS. 1-3. Additionally, or alternatively, one or more operations described above with reference to FIGS. 1-3 may be combined with one or more operations described with reference to FIG. 7 or 8.

In one or more aspects, techniques for supporting determination of a UE beam for Msg3 transmission may include additional aspects, such as any single aspect or any combination of aspects described below or in connection with one or more other processes or devices described elsewhere herein. In a first aspect, supporting determination of a UE beam for Msg3 transmission may include an apparatus configured to transmit, to a network node, a first physical random access channel (PRACH) transmission and one or more repetitions of the first PRACH transmission using a plurality of beams, receive, from the network node, a response to the first PRACH transmission comprising an indication of a selected beam of the plurality of beams, determine the selected beam based on the indication of the selected beam and based on transmission of the first PRACH transmission and one or more repetitions of the first PRACH transmission using the plurality of beams, and transmit one or more message three (Msg3) transmissions to the network node using the selected beam. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with one or more of the above aspects, the response comprises at least one of a Msg2 transmission or a Msg2 PDCCH transmission.

In a third aspect, alone or in combination with one or more of the above aspects, the indication of the selected beam comprises a first bitfield of the response indicating the selected beam.

In a fourth aspect, alone or in combination with one or more of the above aspects, the first bitfield is designated, when a second PRACH transmission and repetitions of the second PRACH transmission are transmitted using a same beam, for transmission of at least one of: transmit power control information, frequency domain resource allocation information, modulation and coding scheme information, cell radio network temporary identifier (C-RNTI) information, or reserved bitfield information.

In a fifth aspect, alone or in combination with one or more of the above aspects, the indication of the selected beam comprises an RA-RNTI of the response.

In a sixth aspect, alone or in combination with one or more of the above aspects, the indication of the selected beam comprises a location of one or more CCEs of the response inside a CORESET of the response.

In a seventh aspect, alone or in combination with one or more of the above aspects, the indication of the selected beam comprises an index of a first CCE of the response.

In an eighth aspect, alone or in combination with one or more of the above aspects, the apparatus is further configured to receive an indication of a mapping of one or more CCE indexes to one or more PRACH opportunities (ROs).

In one or more aspects, techniques for supporting determination of a UE beam for Msg3 transmission may include additional aspects, such as any single aspect or any combination of aspects described below or in connection with one or more other processes or devices described elsewhere herein. In a ninth aspect, supporting determination of a UE beam for Msg3 transmission may include an apparatus configured to receive, from a UE, a first physical random access channel (PRACH) transmission and one or more repetitions of the first PRACH transmission using a plurality of beams, select a beam of the plurality of beams, determine an indication of the selected beam of the plurality of beams based on receipt of the first PRACH transmission and the one or more repetitions of the first PRACH transmission using the plurality of beams, and transmit, to the UE, a response to the first PRACH transmission comprising the determined indication of the selected beam of the plurality of beams. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a tenth aspect, alone or in combination with one or more of the above aspects, the response comprises at least one of a Msg2 transmission or a Msg2 PDCCH transmission.

In an eleventh aspect, alone or in combination with one or more of the above aspects, the apparatus is further configured to receive, from the UE, one or more Msg3 transmissions using the selected beam.

In a twelfth aspect, alone or in combination with one or more of the above aspects, the indication of the selected beam comprises a first bitfield of the response indicating the selected beam.

In a thirteenth aspect, alone or in combination with one or more of the above aspects, the first bitfield is designated, when a second PRACH transmission and repetitions of the second PRACH transmission are transmitted using a same beam, for transmission of at least one of transmit power control information, frequency domain resource allocation information, modulation and coding scheme information, cell radio network temporary identifier (C-RNTI) information, or reserved bitfield information.

In a fourteenth aspect, alone or in combination with one or more of the above aspects, the indication of the selected beam comprises an RA-RNTI of the response.

In a fifteenth aspect, alone or in combination with one or more of the above aspects, the indication of the selected beam comprises a location of one or more CCEs of the response inside a CORESET of the response.

In a sixteenth aspect, alone or in combination with one or more of the above aspects, the indication of the selected beam comprises an index of a first CCE of the response.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 and 7-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented. Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
transmitting, to a first network node, a first physical random access channel (PRACH) transmission and one or more repetitions of the first PRACH transmission using a plurality of beams;
receiving, from the first network node, a response to the first PRACH transmission comprising an indication of a selected beam of the plurality of beams;
determining the selected beam based on the indication of the selected beam and based on transmission of the first PRACH transmission and one or more repetitions of the first PRACH transmission using the plurality of beams; and
transmitting one or more message three (Msg3) transmissions to the first network node using the selected beam.

2. The method of claim 1, wherein the response comprises at least one of:
a message two (Msg2) transmission; or
a Msg2 physical downlink control channel (PDCCH) transmission.

3. The method of claim 1, wherein the indication of the selected beam comprises a first bitfield of the response indicating the selected beam.

4. The method of claim 3, wherein the first bitfield is designated, when a second PRACH transmission and repetitions of the second PRACH transmission are transmitted using a same beam, for transmission of at least one of:
transmit power control information;
frequency domain resource allocation information;
modulation and coding scheme information;
cell radio network temporary identifier (C-RNTI) information; or
reserved bitfield information.

5. The method of claim 1, wherein the indication of the selected beam comprises a random access radio network temporary identifier (RA-RNTI) of the response.

6. The method of claim 1, wherein the indication of the selected beam comprises a location of one or more control channel elements (CCEs) of the response inside a control resource set (CORESET) of the response.

7. The method of claim 6, wherein the indication of the selected beam comprises an index of a first CCE of the response.

8. The method of claim 7, further comprising receiving an indication of a mapping of one or more CCE indexes to one or more PRACH opportunities (ROs).

9. A user equipment (UE) comprising:
a memory; and
at least one processor coupled to the memory, wherein the at least one processor is configured to:
transmit, to a first network node, a first physical random access channel (PRACH) transmission and one or more repetitions of the first PRACH transmission using a plurality of beams;
receive, from the first network node, a response to the first PRACH transmission comprising an indication of a selected beam of the plurality of beams;
determine the selected beam based on the indication of the selected beam and based on transmission of the first PRACH transmission and one or more repetitions of the first PRACH transmission using the plurality of beams; and
transmit one or more message three (Msg3) transmissions to the first network node using the selected beam.

10. The UE of claim 9, wherein the response comprises at least one of:
a message two (Msg2) transmission; or
a Msg2 physical downlink control channel (PDCCH) transmission.

11. The UE of claim 9, wherein the indication of the selected beam comprises a first bitfield of the response indicating the selected beam.

12. The UE of claim 11, wherein the first bitfield is designated, when a second PRACH transmission and repetitions of the second PRACH transmission are transmitted using a same beam, for transmission of at least one of:
transmit power control information;
frequency domain resource allocation information;
modulation and coding scheme information;
cell radio network temporary identifier (C-RNTI) information; or
reserved bitfield information.

13. The UE of claim 9, wherein the indication of the selected beam comprises a random access radio network temporary identifier (RA-RNTI) of the response.

14. The UE of claim 9, wherein the indication of the selected beam comprises a location of one or more control channel elements (CCEs) of the response inside a control resource set (CORESET) of the response.

15. The UE of claim 14, wherein the indication of the selected beam comprises an index of a first CCE of the response.

16. The UE of claim 15, wherein the at least one processor is further configured to receive an indication of a mapping of one or more CCE indexes to one or more PRACH opportunities (ROs).

17. A method of wireless communication performed by a network node, the method comprising:
receiving, from a user equipment (UE), a first physical random access channel (PRACH) transmission and one or more repetitions of the first PRACH transmission using a plurality of beams;
selecting a beam of the plurality of beams;
determining an indication of the selected beam of the plurality of beams based on receipt of the first PRACH transmission and the one or more repetitions of the first PRACH transmission using the plurality of beams; and
transmitting, to the UE, a response to the first PRACH transmission comprising the determined indication of the selected beam of the plurality of beams.

18. The method of claim 17, further comprising receiving, from the UE, one or more message three (Msg3) transmissions using the selected beam.

19. The method of claim 17, wherein the indication of the selected beam comprises a first bitfield of the response indicating the selected beam.

20. The method of claim 19, wherein the first bitfield is designated, when a second PRACH transmission and repetitions of the second PRACH transmission are transmitted using a same beam, for transmission of at least one of:
transmit power control information;
frequency domain resource allocation information;
modulation and coding scheme information;
cell radio network temporary identifier (C-RNTI) information; or
reserved bitfield information.

21. The method of claim 17, wherein the indication of the selected beam comprises a random access radio network temporary identifier (RA-RNTI) of the response.

22. The method of claim 17, wherein the indication of the selected beam comprises a location of one or more control channel elements (CCEs) of the response inside a control resource set (CORESET) of the response.

23. A network node, comprising:
a memory; and
at least one processor coupled to the memory, wherein the at least one processor is configured to:
receive, from a user equipment (UE), a first physical random access channel (PRACH) transmission and one or more repetitions of the first PRACH transmission using a plurality of beams;
select a beam of the plurality of beams;
determine an indication of the selected beam of the plurality of beams based on receipt of the first PRACH transmission and the one or more repetitions of the first PRACH transmission using the plurality of beams; and
transmit, to the UE, a response to the first PRACH transmission comprising the determined indication of the selected beam of the plurality of beams.

24. The network node of claim 23, wherein the response comprises at least one of:
a message two (Msg2) transmission; or
a Msg2 physical downlink control channel (PDCCH) transmission.

25. The network node of claim 23, wherein the at least one processor is further configured to receive, from the UE, one or more message three (Msg3) transmissions using the selected beam.

26. The network node of claim 23, wherein the indication of the selected beam comprises a first bitfield of the response indicating the selected beam.

27. The network node of claim 26, wherein the first bitfield is designated, when a second PRACH transmission and repetitions of the second PRACH transmission are transmitted using a same beam, for transmission of at least one of:
transmit power control information;
frequency domain resource allocation information;
modulation and coding scheme information;
cell radio network temporary identifier (C-RNTI) information; or
reserved bitfield information.

28. The network node of claim 23, wherein the indication of the selected beam comprises a random access radio network temporary identifier (RA-RNTI) of the response.

29. The network node of claim 23, wherein the indication of the selected beam comprises a location of one or more control channel elements (CCEs) of the response inside a control resource set (CORESET) of the response.

30. The network node of claim 29, wherein the indication of the selected beam comprises an index of a first CCE of the response.
